(19) United States
(12) Patent Application Publication
(10) Pub. No.: US 2005/0094386 A1
(43) Pub. Date: May 5, 2005

(54) Sawing direction positioning system for a bench saw

(76) Inventors: Ross Zhang, Shandong Province (CN); Yingjie Li, Shandong Province (CN); Jianjin Guo, Shandong Province (CN)

Correspondence Address: RATNERPRESTIA, P O BOX 980, VALLEY FORGE, PA, 19482-0980, US

(21) Appl. No.: 10/951,093

(22) Filed: Sep. 27, 2004

(30) Foreign Application Priority Data
Oct. 10, 2003 (CN) 200320106024.2
Dec. 15, 2003 (CN) 200320121345.X
Oct. 10, 2003 (CN) 200320106123.0
Nov. 27, 2003 (CN) 200320121027.3
Nov. 27, 2003 (CN) 200320121028.8
Mar. 2, 2004 (CN) 200420038889.4

(51) Int. Cl. B25B 23/16

(52) U.S. Cl. 362/119; 362/259

(57) ABSTRACT

The present invention relates to a sawing direction positioning system for a bench saw having a light-emitting unit for emitting a planar light beam installed at a protection plate of the bench saw. The light-emitting unit has a power supply via a lead and is positioned so that the planar light beam coincides exactly with the central plane of a circular saw blade mounted on the bench saw. During sawing, the projection line of the planar light beam always projects on the wood to be sawed and is not obstructed by sawdust. The operator has a good visual field and pushes the wood to be sawed forwardly along the right straight line to ensure that the sawing direction is correct or keeps in line with the drawn straight line, thus preventing the kerf from offsetting and reducing the rejected products.

### FIELD OF THE INVENTION

The present invention relates to a positioning system, and more particularly, to a sawing direction positioning system for a bench saw.

### DESCRIPTION OF THE BACKGROUND ART

A bench saw is a woodworking machine that saws linearly a wood. When a conventional bench saw is used to saw a wood, a guide plate is preset appropriately on the bench saw and the wood to be sawed is then pushed forwardly against the guide plate during working. In other way, a straight line is drawn on the wood to be sawed beforehand and the wood to be sawed is then pushed forwardly along the straight line during working. During sawing, one operator should keep his eyes on the position of the wood to ensure that the sawing direction is correct or keeps in line with the drawn straight line, thereby preventing the kerf from offsetting. However, other things such as sawdust may obstruct the operator's sight line so that it is difficult for the operator to control the sawing, thereby resulting in many rejected products.

A conventional sawing direction positioning system using laser beam was known. This system may be attached to a circular saw blade and rotate along with the circular saw blade while emitting a straight beam. The straight beam projecting on the wood to be sawed forms a straight line to mark sawing direction. However, this system is very complicate in structure because it is power-supplied via an electrical brush.

### SUMMARY OF THE INVENTION

An object of the invention is to overcome the defects and problems in the prior art and provide a sawing direction positioning system for a bench saw, which may reduce mismachining tolerance in shape and size, avoid the defects of complicated and vulnerable electrical brush, have simple structure and convenience in adjustment, and emit lights of various colours that do not injure the operator's eyes to meet the requirements in different applications.

To achieve the object of the invention, there is provided a sawing direction positioning system for a bench saw comprising a light-emitting unit for emitting a planar light beam installed at a protection plate of said bench saw, said light-emitting unit being connected with a power supply via a lead and positioned to emit forward and downward said planar light beam so that said planar light beam coincides exactly with the central plane of a circular saw blade mounted on said bench saw. The projection line of the planar light beam on a wood to be sawed is a very fine straight line which marks the sawing direction for the circular saw blade.

By adjusting a mounting screw, the sawing direction positioning system for a bench saw according to the present invention is installed so that its centre line coincides exactly with the central plane of a circular saw blade. In operation, the sawing direction positioning system for a bench saw is switched on and the planar light beam emitted from the light-emitting unit projects a very straight line on the wood. During sawing, by manually adjusting the wood, the projection line always passes through the marked dots or keeps alignment with the drawn line on the wood, and the saw blade always saws the wood along the projection line. Thus, a desirable kerf is worked. The projection line is very clear and isn't obstructed by the sawdust, thereby reducing the reject rate and avoiding any waste.

The power supply may be a permanent magnet generator comprising two permanent magnets provided symmetrically on a shaft of the motor of the bench saw, two windings connected in series and attached to the frame of the bench saw and the lead connecting the two windings with the light-emitting unit. The two permanent magnets and the two windings are located so that the distances from their axes to the axis of the shaft of the motor are equal to each other. In operation, the two permanent magnets rotate synchronously with the shaft of the motor of the bench saw and the resultant magnetic lines are cut by two windings, thereby generating an induced voltage in the windings to supply the light-emitting unit. In this way, the complicated and vulnerable electrical brush may be omitted. The sawing direction positioning system may be controlled automatically because a planar light beam is emitted so long as the motor rotates. In addition, no other power supply is provided, thereby saving energy.

The light-emitting unit may use a light emitting diode as its light source to emit a visible light.

Alternatively, the light-emitting unit may use a laser diode as its light source. Such light-emitting unit has intensive energy and the light emitted from it is clearer and more brilliant.

The light emitting diode may be one of a monochromatic light emitting diode, a two-color light emitting diode or a RGB light emitting diode. The two-color light emitting diode or the RGB light emitting diode may emit a monochromatic light as required under control of a control circuit. To make the very fine straight line clear, the colour of the planar light beam is selected to contrast greatly with that of the wood to be sawed, for example, white, blue or red colour. That is to say, one respective light emitting diode may be selected to emit a planar light beam of respective colour. In case that one two-color light emitting diode is used, it is possible to emit a desired monochromatic light under control of the control circuit. In case that one RGB light emitting diode is used, by means of the control circuit it is possible not only to emit a trichromatic light of red, green and blue, but also to emit a light of any color. The light emitting diode doesn't injure the operator's eyes and safe and inexpensive.

The light emitting diode may be installed in a paraboloid reflecting mirror provided with a hole for heat dispersion at rear end, and the light emitted from the light-emitting unit passes through a group of lens to form the planar light beam. Such arrangement may further increase the efficiency of the light emitting diode and make the light beam clearer.

The orientation of the light-emitting unit is adjustable so that it is more convenient for use.

The group of lens may comprise a converging lens disposed coaxially in front of the light emitting diode or the laser diode and a cylindrical lens disposed coaxially in front of the converging lens. The light emitted from the light source is converged by the converging lens and then passes through the cylindrical lens to form the planar light beam. Of course, a corrugated lens may be used instead of the cylindrical lens. Other optical elements are suitable for such use.

The object of the invention therefore is achieved.

The sawing direction positioning system for a bench saw according to the present invention is simple and low-cost. During sawing, adjustment may be made easily so that the wood to be sawed is positioned rapidly and accurately along a correct sawing direction. It can be used widely in various bench saws.

### BRIEF DESCRIPTION OF THE DRAWINGS

FIG. 1 is a schematic view showing a bench saw provided with a sawing direction positioning system according to the present invention.

FIG. 2 is a schematic view showing a permanent magnet generator according to the present invention.

FIG. 3 is a schematic diagram showing the light-emitting unit according to the present invention.

FIG. 4 is a schematic diagram showing the light-emitting unit according to another embodiment of the present invention.

### DETAILED DESCRIPTION OF THE PREFERRED EMBODIMENTS

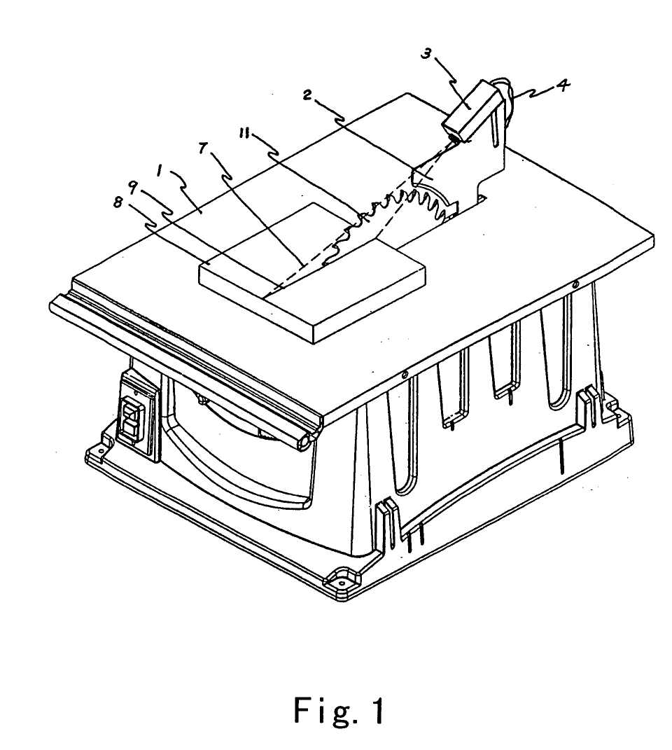

As shown in FIGS. 1 and 3, one light-emitting unit 3 for emitting a planar light beam is installed at a protection plate 2 of a bench saw 1. The light-emitting unit 3 is connected with a power supply via a lead 4. The light-emitting unit 3 may emit forward and downward a planar light beam 7 which coincides exactly with the central plane of a circular saw blade 11 mounted on the bench saw. The projection line of the planar light beam 7 on a wood 8 to be sawed, i.e. the intersecting line of the planar light beam 7 and the wood 8 is a very fine straight line 9.

The light-emitting unit 3 according to the present invention uses a light emitting diode 14 as its light source to emit a visible light. The light emitting diode 14 is a RGB light emitting diode. The light-emitting unit 3 also includes a control circuit 17. The light emitted from the light-emitting unit 3 passes through a group of lens 13 to form the planar light beam 7. The light emitting diode 14 is installed in a paraboloid reflecting mirror 5 provided with a hole 6 for heat dispersion at rear end.

Alternatively, the light emitting diode 14 is a two-color light emitting diode emitting red and white light. The two-color light emitting diode is controlled by the control circuit 17 to emit red or white light as required.

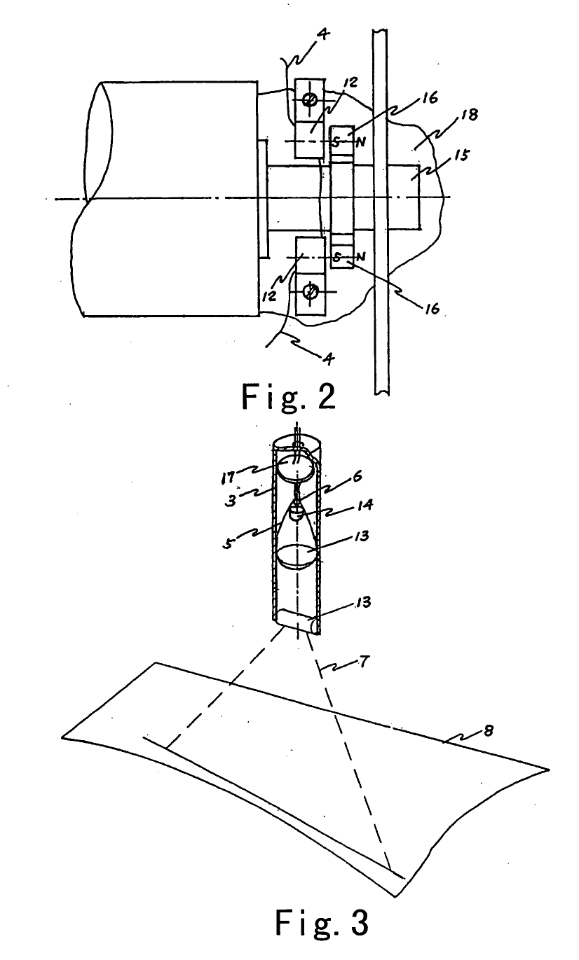

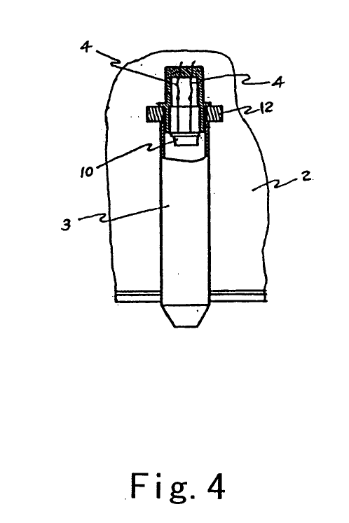

As shown in FIGS. 2 and 4, the sawing direction positioning system for a bench saw according to the present invention is power-supplied by a permanent magnet generator. The permanent magnet generator comprises two permanent magnets 16 provided symmetrically on a shaft 15 of the motor of the bench saw 1, two windings 12 connected in series and attached to the frame 18 of the bench saw 1 and the lead 4 connecting two windings 12 with the light-emitting unit 3. Two permanent magnets 16 and two windings 12 are located so that the distances from their axes to the axis of the shaft 15 of the motor are equal to each other. Alternatively, the light-emitting unit 3 may use a laser diode 10 as its light source and be installed at the protection plate 2.

The sawing direction positioning system for a bench saw as described above marks the sawing direction by means of a planar light beam, thereby increasing the rate of finished products, meeting the requirements for colours in different applications, simplifying the structure and providing convenience in adjustment. The sawing direction positioning system may be used widely in various bench saws.

Having described the invention in detail, those skilled in the art will appreciate that modifications of this invention may be made without departing from its spirit. Therefore, it is not intended to limit the present invention only to the preferred embodiments illustrated and described. Rather, the scope of the invention is to be determined by the appended claims and their equivalents.

This application incorporates by reference the patent applications titled:
“SAWING DIRECTION POSITIONING SYSTEM FOR A WOODWORKING BANDSAW” to Ross Zhang; and
“SAWING DIRECTION POSITIONING SYSTEM FOR A JIGSAW” to Ross Zhang filed concurrently herewith.

1. A sawing direction position system for a bench saw comprising a light-emitting unit for emitting a planar light beam installed at a protection plate of said bench saw, said light-emitting unit being connected with a power supply via a lead and positioned to emit said planar light beam forward and downward so that said planar light beam coincides exactly with a central pane of a circular saw blade mounted on said bench saw.

2. A sawing direction positioning system as claimed in claim 1, wherein said power supply is a permanent magnet generator comprising two permanent magnets provided symmetrically on a shaft of a motor of said bench saw, two windings connected in series and attached to a frame of said bench saw and the lead connecting said two windings with said light-emitting unit.

3. A sawing direction positioning system as claimed in claim 2, wherein said two permanent magnets and said two windings are located so that the distance from their axes to an axis of the shaft of the motor are equal to each other.

4. A sawing direction positioning system as claimed in claim 1, wherein said light-emitting unit uses a light emitting diode as its light source to emit a visible light.

5. A sawing direction positioning system as claimed in claim 1, wherein said light-emitting unit uses a laser diode as its light source.

6. A sawing direction positioning system as claimed in claim 4, wherein said light emitting diode is one of a group consisting of a monochromatic light emitting diode, a two-color light emitting diode and a RGB light emitting diode.

7. A sawing direction positioning system as claimed in claim 4, wherein said light-emitting unit also includes a control circuit, and a two-color light emitting diode or a RGB light emitting diode that emits a monochromatic light as required by means of the control circuit.

8. A sawing direction positioning system as claimed in claim 4, wherein said light emitting diode is installed in a paraboloid reflecting mirror provided with a hole for heat dispersion at a rear end, and the light emitted from the light-emitting unit passes through a group of lens to form said planar light beam.
